(19) United States
(12) Patent Application Publication
(10) Pub. No.: US 2026/0093111 A1
(43) Pub. Date: Apr. 2, 2026

(54) ACHROMATIC POSITION-AGNOSTIC OPTICS

(71) Applicant: Baker Hughes Holdings LLC, Houston, TX (US)

(72) Inventors: Jakub Prchlik, Solon, OH (US); James Tunningley, Strongsville, OH (US); Anson Bajramaj, Willowick, OH (US)

(21) Appl. No.: 19/321,377

(22) Filed: Sep. 8, 2025

Related U.S. Application Data
(60) Provisional application No. 63/701,879, filed on Oct. 1, 2024.

(51) Int. Cl. G02B 27/00; G02B 27/09

(52) U.S. Cl. CPC G02B 27/0056; G02B 27/0994

(57) ABSTRACT

An optical system includes an optical target for receiving an extended light source that emits a first light beam at a first radial distance from an optical axis and a second light beam at a second radial distance from the optical axis. The first light beam and the second light beam both have a first wavelength and a second wavelength. A first lens system is located between the extended light source and the optical target. A second lens system is located between the first lens system and the optical target. A first collection probability of the first light beam at the first wavelength, a second collection probability of the first light beam at the second wavelength, a third collection probability of the second light beam at the first wavelength, and a fourth collection probability of the second light beam at the second wavelength are the same within a criterion.

### CROSS REFERENCE TO RELATED APPLICATIONS

This application claims the benefit of an earlier filing date from U.S. Provisional Application Ser. No. 63/701,879 filed Oct. 1, 2024, the entire disclosure of which is incorporated herein by reference.

### BACKGROUND

Chemiluminescence from a power generating flame, such as within a combustion chamber of an internal combustion engine, can be used to provide information relating to the combustion, such as, but not limited to, a temperature of the combustion within the combustion chamber. Such information can be used to adjust operating parameters of the internal combustion engine, troubleshoot problems with the engine, or predict maintenance schedules of the engine. The combustion flame is an extended light source having a broadband spectrum and its spatial position can change dynamically. This dynamic change in position can affect a collection probability of the light that is generated by the flame and received at a detector. A varying collection probability can affect the consistency of measurements made of the flame. Thus, there is a need for obtaining a same collection probability at a detector of light emitted from an extended light source.

### SUMMARY

In one aspect, an optical system is disclosed. The optical system includes an optical target for receiving a first light beam emitted from an extended light source at a first radial distance from an optical axis and a second light beam emitted from the extended light source at a second radial distance from the optical axis of the optical system, the first light beam having a first wavelength and a second wavelength and the second light beam having the first wavelength and the second wavelength, wherein the optical axis passes through the extended light source and the optical target, a first lens system located along the optical axis between the extended light source and the optical target, wherein the first lens system is an achromatic lens system, and a second lens system located along the optical axis between the first lens system and the optical target. wherein a first collection probability of the first light beam at the first wavelength at the optical target, a second collection probability of the first light beam at the second wavelength at the optical target, a third collection probability of the second light beam at the first wavelength at the optical target, and a fourth collection probability of the second light beam at the second wavelength at the optical target are the same within a criterion.

In another aspect, a method of integrating a light source is disclosed. The light source is disposed along an optical axis passing through an optical target, wherein the light source emits a first light beam having a first wavelength and a second wavelength at a first radial distance from the optical axis and a second light beam having the first wavelength and the second wavelength at a second radial distance from the optical axis. A first lens system is disposed along the optical axis between the extended light source and the optical target, wherein the first lens system is an achromatic lens system. A second lens system is disposed along the optical axis between the first lens system and the optical target, wherein the first light beam at the first wavelength passes through the first lens system and the second lens system to illuminate the optical target with a first collection probability, the first light beam at the second wavelength passes through the first lens system and the second lens system to illuminate the optical target with a second collection probability, the second light beam at the first wavelength passes through the first lens system and the second lens system to illuminate the optical target with a third collection probability, and the second light beam at the second wavelength passes through the first lens system and the second lens system to illuminate the optical target with a fourth collection probability. At least one of a first location of the first lens system and a second location of the second lens system are adjusted so that the first collection probability, the second collection probability, the third collection probability, and the fourth collection probability are the same within a criterion.

### BRIEF DESCRIPTION OF THE DRAWINGS

The following descriptions should not be considered limiting in any way. With reference to the accompanying drawings, like elements are numbered alike:

FIG. 1 shows an optical device in a perspective view, in an embodiment;

FIG. 2 shows a schematic diagram of an optical system that includes the optical device of FIG. 1, in an embodiment;

FIG. 3 is a schematic diagram showing the optical elements of the optical system in a side view with an off-axis source at two wavelengths;

FIG. 4 is a schematic diagram showing the optical elements of the optical system in a side view with an on-axis source at two wavelengths;

FIG. 5 is a graph showing collection efficiency of light at the optical target for various wavelengths;

FIG. 6 shows a schematic of a flame from a combustion engine with multiple wavelengths, scales, and positions of emitted light; and

FIG. 7 is a graph illustrating allowed locations for the lens elements of the optical system in an embodiment.

### DETAILED DESCRIPTION

A detailed description of one or more embodiments of the disclosed apparatus and method are presented herein by way of exemplification and not limitation with reference to the Figures.

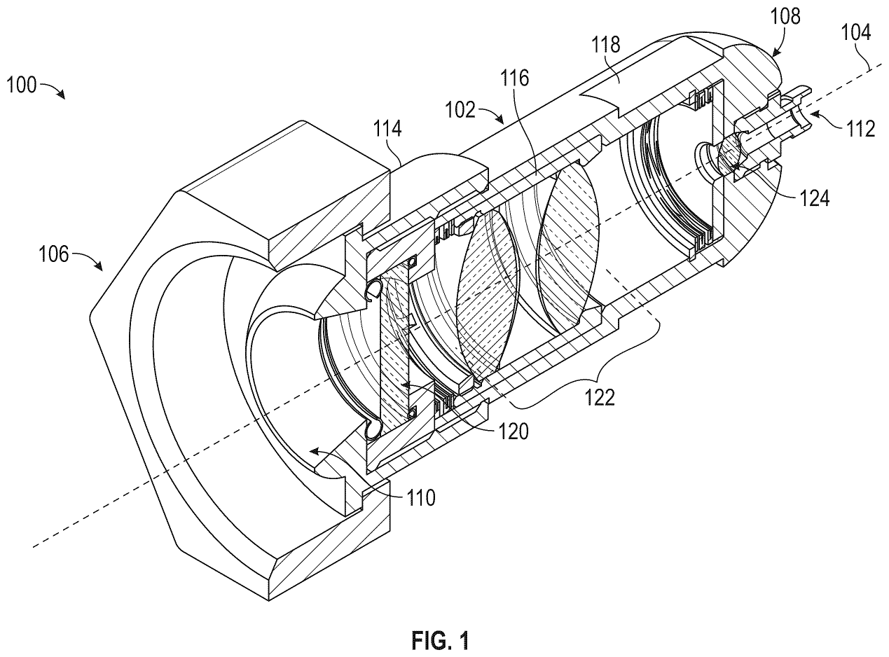

Referring to FIG. 1, an optical device 100 is shown in a perspective view, in an illustrative embodiment. The optical device 100 includes a housing 102 that extends along a longitudinal axis 104. The housing 102 includes a hollow bore extending from a first end 106 to a second end 108 along the longitudinal axis 104. A first opening 110 is located at the first end 106 and a second opening 112 is located at the second end 108. Light enters the housing 102 via the first opening 110 and exits the housing 102 via the second opening 112.

The housing 102 includes a first section 114, a second section 116 and a third section 118 which are able to be positioned along the longitudinal axis 104 independently of each other. Each section houses a separate optical element. The first section 114 houses a sapphire window 120. The second section 116 houses a first lens system 122. The third section 118 houses a second lens system 124. The sapphire window 120, the first lens system 122 and the second lens system 124 are located along the longitudinal axis 104. The optical axes of the sapphire window 120, the first lens system 122 and the second lens system 124 are arranged within the housing 102 to be collinear with each other as well as collinear with the longitudinal axis 104. Thus, the longitudinal axis 104 of the optical device 100 is also referred to herein as the optical axis. A first focal length of the first lens system 122 is greater than a second focal length of the second lens system 124.

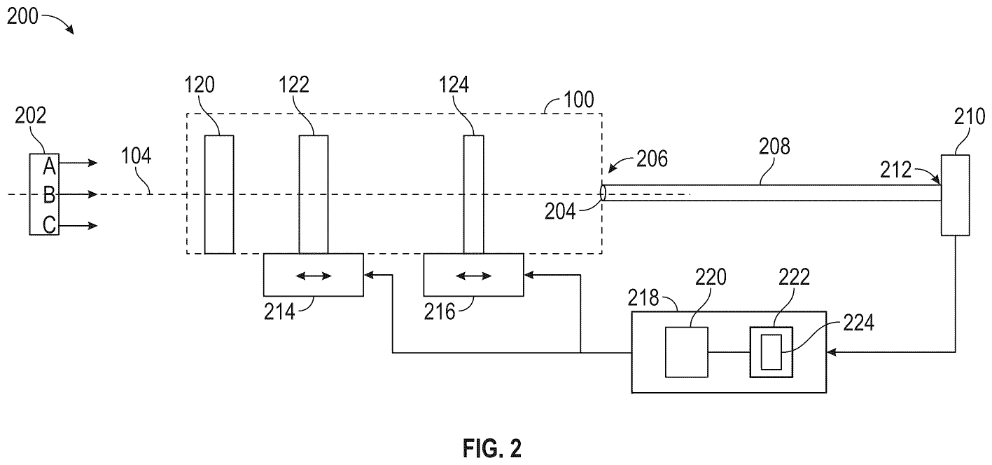

FIG. 2 shows a schematic diagram of an optical system 200 that includes the optical device 100 of FIG. 1, in an illustrative embodiment. The optical system 200 can be used to integrate light from a light source. The optical device 100 is placed within the optical system 200 between a light source 202 and an optical target 204. Each of the light source 202 and the optical target 204 are located along the optical axis (i.e., longitudinal axis 104) of the optical device 100. The light source 202 is an extended light source that extends in a radial direction or perpendicular direction from the optical axis and within a source plane. The light source 202 emits light from points along the optical axis as well as at radial distances away from the optical axis.

For purposes of illustration, three points (A, B, C) of the light source 202 are shown at various radial positions with respect to the optical axis. Point A is above the optical axis, point B is on the optical axis, and point C is below the optical axis. The optical target 204 is within the target plane that is perpendicular to the optical axis and has a collection area located with the target plane. A first cross-sectional area of the light source 202 within the source plane is greater than a second cross-sectional area of the optical target (collection area) within the target plane 304. In an embodiment, the optical target 204 can include an aperture of an optical fiber 208. The aperture is located at a first end 206 of the optical fiber 208. In various embodiments, the aperture has a radius of about 0.5 millimeters. A detector 210 is connected to a second end 212 of the optical fiber 208. The detector 210 can perform an analysis of light received from the optical fiber 208.

The first lens system 122 is disposed between the light source 202 and the optical target 204. The second lens system 124 is disposed between the first lens system 122 and the optical target 204. The sapphire window 120 is disposed at the first end 106 between the first lens system 122 and the light source 202. A first stepper motor 214 can move the first lens system 122 along the optical axis. A second stepper motor 216 can move the second lens system 124 along the optical axis. In alternative embodiments, the optical system can also include additional stepper motors for changing the locations of one or more other components of the optical system 200.

The first lens system 122 is an achromatic lens system that reduces chromatic dispersion of light. The first lens system 122 can include a single lens or a plurality of lenses. In an embodiment, the first lens system 122 is a Cooke triplet. The Cooke triplet includes a first convex-convex lens, a second convex-convex lens and a concave-concave lens between the first convex-convex lens and the second convex-convex lens. The concave-concave lens is in contact with both the first convex-convex lens and the second convex-convex lens. The first convex-convex lens and the second convex-convex lens can be composed of magnesium fluoride or calcium fluoride. The concave-concave lens can be composed of silica glass or magnesium fluoride. In an embodiment, the first lens system 122 and the second lens system 124, in combination, form a Koehler lens system.

Light from the light source 202 passes through the sapphire window 120, the first lens system 122 and the second lens system 124 to enter the optical fiber 208 at the aperture (optical target 204). The light then passes through the optical fiber 208 to be received at the detector 210. The detector 210 can provide a signal to a controller 218 based on the received light.

The controller 218 includes a processor 220 and a memory storage device 222 including programs 224 stored thereon. The processor 220 can access the programs 224 to perform the methods disclosed herein. In one embodiment, the controller 218 can determine a parameter of the light and/or of the light source 202 from the signal. The controller 218 can also control operation of the first stepper motor 214 and the second stepper motor 216 to change one or more of a first location of the first lens system 122 and a second location of the second lens system 124 based on calculations performed at the controller 218. In particular, the calculations determine a location for the first lens system and the second lens system at which a first collection probability of a first light beam at the optical target/aperture is the same as a second collection probability of a second light beam at the optical target/aperture, as disclosed herein. The controller 218 can also control movement of any of the additional stepper motors of various alternative embodiments.

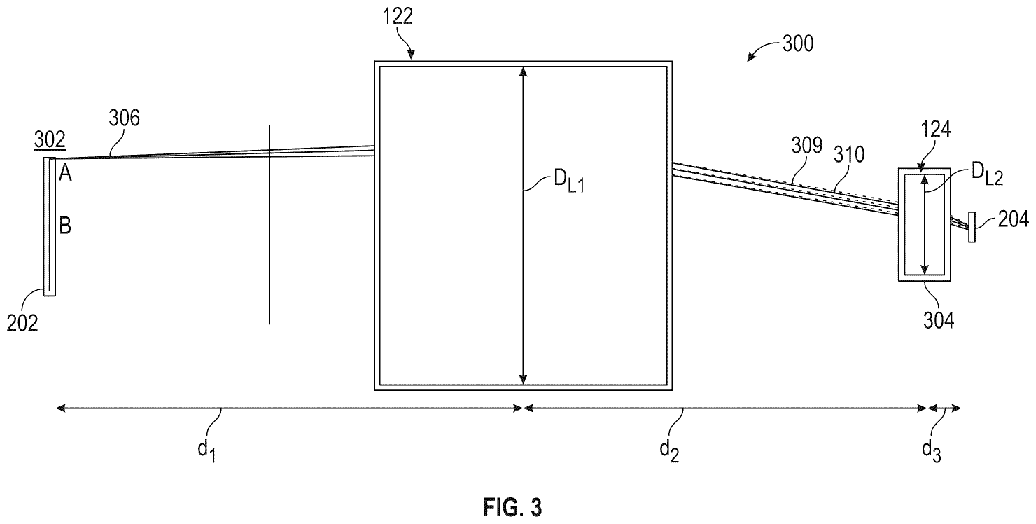

FIG. 3 is a schematic diagram 300 showing the optical elements of the optical system 200 in a side view with an off-axis source at two wavelengths. The schematic diagram 300 shows a source plane 302, the first lens system 122, the second lens system 124 and a target plane 304. The light source 202 is located at the source plane 302 and the optical target 204 is located at the target plane 304. The source plane 302 is separated from the first lens system 122 by a first distance d₁. The first lens system 122 is separated from the second lens system 124 by a second distance d₂. The second lens system 124 is separated from the optical target 204 by a third distance d₃.

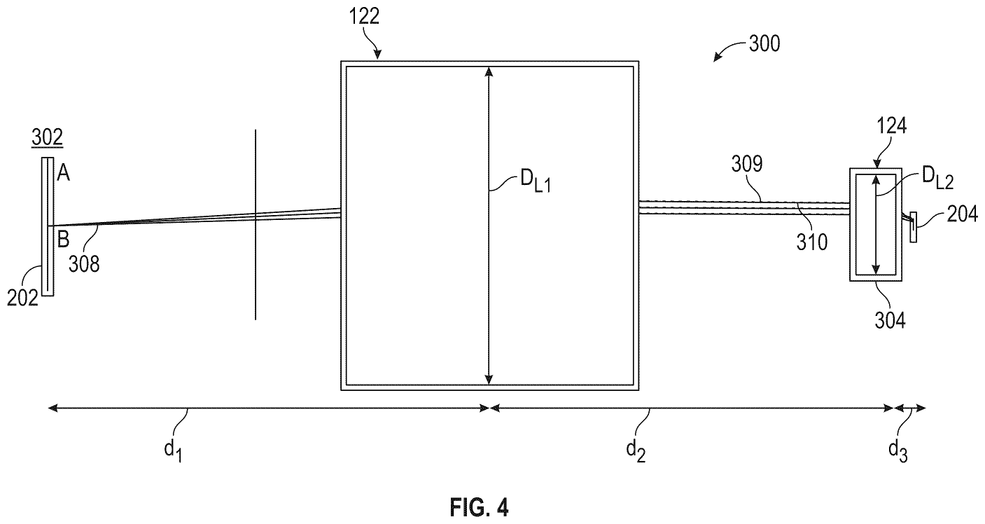

The light source 202 emits light from a plurality of points that are off of the optical axis. A first light beam 306 (see FIG. 3) and a second light beam 308 (see FIG. 4) are selected for purposes of explanation. The first light beam 306 is emitted from a first point (point A) at a first radial distance from the optical axis. The second light beam 308 is emitted from a second point (point B) at a second radial distance from the optical axis. In various embodiments, a first wavelength of the first light beam 306 can be different than a second wavelength of the second light beam 308. However, the first light beam 306 and the second light beam 308 can have a same wavelength or same wavelengths, in other embodiments.

The first light beam 306 having a first wavelength 309 and second wavelength 310 is incident at the first lens system 122. The first light beam 306 diverges from point A to illuminate the first lens system 122. The achromatic nature of the first lens system 122 causes the first light beam at the first wavelength 309 and the first light beam at the second wavelength 310 to be incident at the second lens system 124 with identical initial conditions. From the second lens system 124, the first light beam 306 having the first wavelength 309 is directed at the optical target to illuminate the optical target with a first collection probability and the first light beam 306 having the second wavelength 310 is directed at the optical target to illuminate the optical target with a second collection probability. The first collection probability (of the first light beam 306 emitted from a first radial distance from the optical axis and having a first wavelength 309) is the same as the second collection probability (of the first light beam 306 emitted from the first radial distance from the optical axis and having a second wavelength 310), within a criterion.

In various embodiments, the criterion is that the first collection probability and the second collection probability are within 10% of each other within a selected range of wavelengths. The range of wavelengths for which the first collection probability and the second collection probability are within the criterion can extend over a suitable range, such as from 250 nanometers (nm) to 800 nm.

FIG. 4 is a schematic diagram 400 showing the optical elements in a side view with an on-axis source of light at two wavelengths. A second light beam 308 is emitted from point B with first wavelength 309 and second wavelength 310. Similar to the first light beam 306 of FIG. 3, the second beam of light converges on the target with third collection probability (for first wavelength 309) the same as the fourth collection probability (for second wavelength 310), similar to the first light beam 306 of FIG. 3.

In one embodiment, the first collection probability, the second collection probability, the third collection probability and the fourth collection probability are the same, within the criterion. In other embodiments, the first collection probability is the same as at least one of the second collection probability, the third collection probability and the fourth collection probability, within the criterion. In another embodiment, the first collection probability is the same as the fourth collection probability, within the criterion.

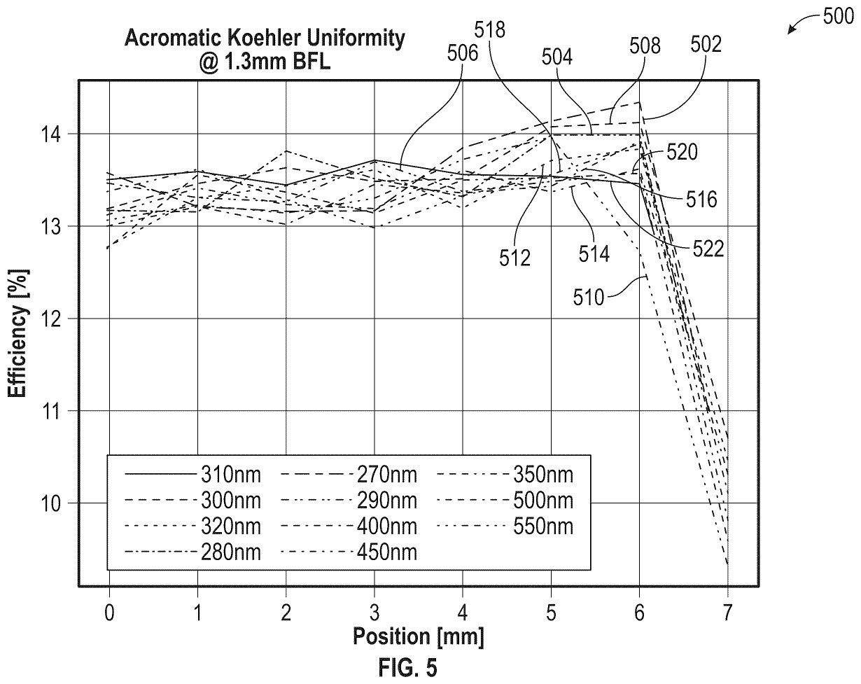

FIG. 5 is a graph 500 showing collection efficiency of light at the optical target for various wavelengths. A radial distance from the optical axis is shown along the abscissa in millimeters (mm) and a collection efficiency is shown along the ordinate axis in percentage (%). Curves show collection efficiencies for various wavelengths. Curve 502 represents a collection efficiency at a wavelength of 270 nm. Curve 504 represents a collection efficiency at a wavelength of 280 nm. Curve 506 represents a collection efficiency at a wavelength of 290 nm. Curve 508 represents a collection efficiency at a wavelength of 300 nm. Curve 510 represents a collection efficiency at a wavelength of 310 nm. Curve 512 represents a collection efficiency at a wavelength of 320 nm. Curve 514 represents a collection efficiency at a wavelength of 350 nm. Curve 516 represents a collection efficiency at a wavelength of 400 nm. Curve 518 represents a collection efficiency at a wavelength of 450 nm. Curve 520 represents a collection efficiency at a wavelength of 500 nm. Curve 522 represents a collection efficiency at a wavelength of 550 nm. The collection efficiencies for each wavelength remain within a selected range (from about 13% and 14%) for radial distances from the optical axis up to about 6 mm.

In various embodiment, the controller 218 calculates positions of the first lens system and the second lens system that cause the collection probabilities for light at different wavelengths to satisfy the criterion. The controller can then adjust a distance between the first lens system and the second lens system as well as a distance between the second lens system and the optical target to make the collection efficiencies at the optical target satisfy the criterion.

The controller 218 can execute a program to loop the first lens system 122 and the second lens system 124 through various distances and measure collection efficiency as a function of wavelength and radial position. Data is analyzed to find intra-optic distances for which the collection efficiency has a minimum change as a function of radial position. The lens systems are moved to locations such that the collection probabilities satisfy the criterion for all wavelengths of interest.

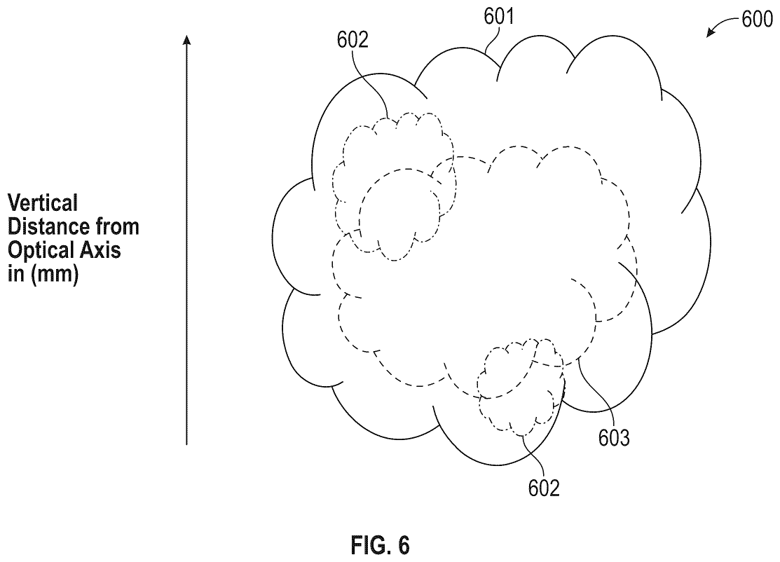

FIG. 6 shows a schematic diagram 600 representing a combustion flame from a combustion engine. The combustion flame is an extended light source within a source plane 302. A distance from a flame origin is shown along the abscissa in millimeters (mm). A radial distance from the optical axis is shown along the ordinate axis in millimeters (mm). The optical axis is at a radial distance of 0. As shown in FIG. 6, the wavelength of light from the combustion flame differs with the radial distance from the optical axis. Light at one wavelength exists over a large area 601 of source plane 302. Light at another wavelength exists at two locations 602 in the source plane, the two locations having limited areas. Light at a third wavelength exists in a limited area 603 of the source plane 302.

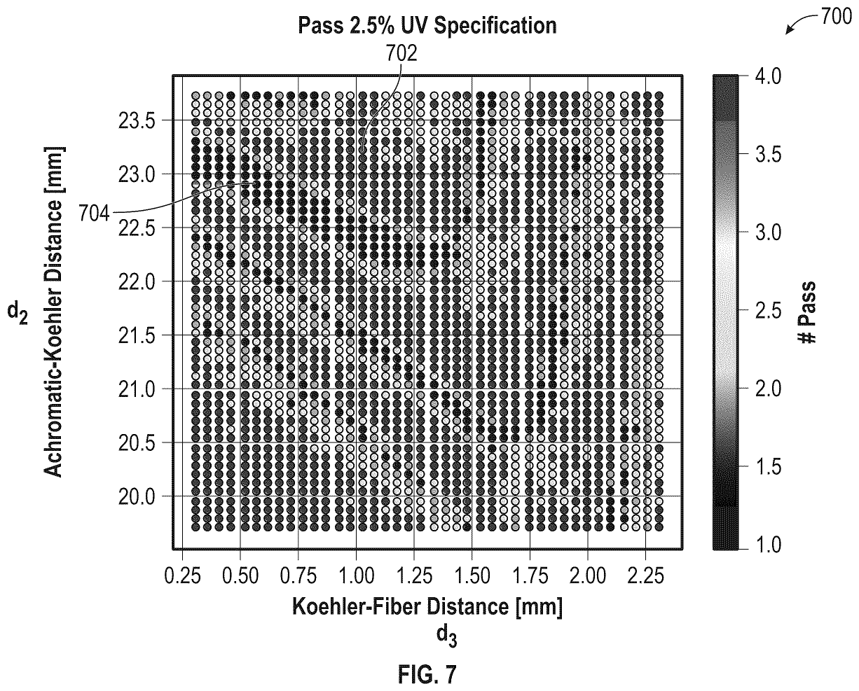

FIG. 7 is a graph 700 illustrating allowed locations for the lens elements of the optical system 200 in an embodiment. The distance d₃ between the second lens system and the optical target 204 is shown along the abscissa in millimeters (mm) and the distance d₂ between the first lens system 122 and the second lens system 124 is shown along the ordinate axis in millimeters (mm). A first region 702 indicates relations between d₁ and d₂ ratios for which collection probabilities at various wavelengths satisfy the criterion. A second region 704 indicates relations between d₁ and d₂ ratios for which collection probabilities at various wavelengths do not satisfy the criterion.

In various embodiments, the optical system can be used in industrial, power generating heavy duty or aeroderivative gas turbines.

Set forth below are some embodiments of the foregoing disclosure:
Embodiment 1. An optical system. The optical system includes an optical target for receiving a first light beam emitted from an extended light source at a first radial distance from an optical axis and a second light beam emitted from the extended light source at a second radial distance from the optical axis of the optical system, the first light beam having a first wavelength and a second wavelength and the second light beam having the first wavelength and the second wavelength, wherein the optical axis passes through the extended light source and the optical target, a first lens system located along the optical axis between the extended light source and the optical target, wherein the first lens system is an achromatic lens system, and a second lens system located along the optical axis between the first lens system and the optical target, wherein a first collection probability of the first light beam at the first wavelength at the optical target, a second collection probability of the first light beam at the second wavelength at the optical target, a third collection probability of the second light beam at the first wavelength at the optical target, and a fourth collection probability of the second light beam at the second wavelength at the optical target are the same within a criterion.
Embodiment 2. The optical system of any prior embodiment, wherein the first lens system and the second lens system combine to form a Koehler lens system.
Embodiment 3. The optical system of any prior embodiment, wherein the first light beam at the first wavelength and the first light beam at the second wavelength arrive from the first lens system at the second lens system with the same initial conditions.
Embodiment 4. The optical system of any prior embodiment, wherein the optical target is an aperture of an optical fiber and defines a collection area, wherein the first collection probability of the first light beam is the same as the second collection probability across the collection area.
Embodiment 5. The optical system of any prior embodiment, wherein the aperture is about 0.5 millimeters in radius.
Embodiment 6. The optical system of any prior embodiment, wherein a first focal length of the first lens system is longer than a second focal length of the second lens system.
Embodiment 7. The optical system of any prior embodiment, wherein the first radial distance and the second radial distance are each within approximately 6 millimeters of the optical axis.
Embodiment 8. The optical system of any prior embodiment, wherein the criterion includes that the first collection probability, the second collection probability, the third collection probability, and the fourth collection probability are within 10% of each other at each radial position of the first light beam and the second light beam.
Embodiment 9. The optical system of any prior embodiment, wherein a selected range of wavelengths for the first wavelength and the second wavelength is between 250 nm and 800 nm.
Embodiment 10. The optical system of any prior embodiment, further including a processor configured to determine at least one of a first location of the first lens system and a second location of the second lens system to allow the first collection probability, the second collection probability, the third collection probability and the fourth collection probability to be the same within the criterion and to move the at least one of the first lens system and the second lens system to the first location and the second location, respectively.
Embodiment 11. A method of integrating a light source is disclosed. The method includes disposing the light source along an optical axis passing through an optical target, wherein the light source emits a first light beam having a first wavelength and a second wavelength at a first radial distance from the optical axis and a second light beam having the first wavelength and the second wavelength at a second radial distance from the optical axis, disposing a first lens system along the optical axis between the extended light source and the optical target, wherein the first lens system is an achromatic lens system, disposing a second lens system along the optical axis between the first lens system and the optical target, wherein the first light beam at the first wavelength passes through the first lens system and the second lens system to illuminate the optical target with a first collection probability, the first light beam at the second wavelength passes through the first lens system and the second lens system to illuminate the optical target with a second collection probability, the second light beam at the first wavelength passes through the first lens system and the second lens system to illuminate the optical target with a third collection probability, and the second light beam at the second wavelength passes through the first lens system and the second lens system to illuminate the optical target with a fourth collection probability, and adjusting at least one of a first location of the first lens system and a second location of the second lens system so that the first collection probability, the second collection probability, the third collection probability, and the fourth collection probability are the same within a criterion.
Embodiment 12. The method of any prior embodiment, wherein the first lens system and the second lens system combine to form a Koehler lens system.
Embodiment 13. The method of any prior embodiment, wherein the first light beam at the first wavelength and the first light beam at the second wavelength arrive from the first lens system at the second lens system with the same initial conditions.
Embodiment 14. The method of any prior embodiment, wherein the optical target includes an aperture of an optical fiber defining a collection area, wherein the first collection probability of the first light beam is the same as the second collection probability across the collection area.
Embodiment 15. The method of any prior embodiment, wherein the aperture is about 0.5 millimeters in radius.
Embodiment 16. The method of any prior embodiment, wherein a first focal length of the first lens system is longer than a second focal length of the second lens system.
Embodiment 17. The method of any prior embodiment, wherein the first radial distance and the second radial distance are each within approximately 6 millimeters of the optical axis.
Embodiment 18. The method of any prior embodiment, wherein the criterion includes that the first collection probability and the second collection probability are within 10% of each other at each radial position of the first light beam and the second light beam.
Embodiment 19. The method of any prior embodiment, wherein a selected range of wavelengths for the first wavelength and the second wavelength is between 250 nm and 800 nm.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of +8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. An optical system, comprising:
an optical target for receiving a first light beam emitted from an extended light source at a first radial distance from an optical axis and a second light beam emitted from the extended light source at a second radial distance from the optical axis of the optical system, the first light beam having a first wavelength and a second wavelength and the second light beam having the first wavelength and the second wavelength, wherein the optical axis passes through the extended light source and the optical target;
a first lens system located along the optical axis between the extended light source and the optical target, wherein the first lens system is an achromatic lens system; and
a second lens system located along the optical axis between the first lens system and the optical target, wherein a first collection probability of the first light beam at the first wavelength at the optical target, a second collection probability of the first light beam at the second wavelength at the optical target, a third collection probability of the second light beam at the first wavelength at the optical target, and a fourth collection probability of the second light beam at the second wavelength at the optical target are the same within a criterion.

2. The optical system of claim 1, wherein the first lens system and the second lens system combine to form a Koehler lens system.

3. The optical system of claim 1, wherein the first light beam at the first wavelength and the first light beam at the second wavelength arrive from the first lens system at the second lens system with the same initial conditions.

4. The optical system of claim 1, wherein the optical target is an aperture of an optical fiber and defines a collection area, wherein the first collection probability of the first light beam is the same as the second collection probability across the collection area.

5. The optical system of claim 4, wherein the aperture is about 0.5 millimeters in radius.

6. The optical system of claim 1, wherein a first focal length of the first lens system is longer than a second focal length of the second lens system.

7. The optical system of claim 1, wherein the first radial distance and the second radial distance are each within approximately 6 millimeters of the optical axis.

8. The optical system of claim 1, wherein the criterion includes that the first collection probability, the second collection probability, the third collection probability, and the fourth collection probability are within 10% of each other at each radial position of the first light beam and the second light beam.

9. The optical system of claim 1, wherein a selected range of wavelengths for the first wavelength and the second wavelength is between 250 nm and 800 nm.

10. The optical system of claim 1, further comprising a processor configured to determine at least one of a first location of the first lens system and a second location of the second lens system to allow the first collection probability, the second collection probability, the third collection probability and the fourth collection probability to be the same within the criterion and to move the at least one of the first lens system and the second lens system to the first location and the second location, respectively.

11. A method of integrating a light source, comprising:
disposing the light source along an optical axis passing through an optical target, wherein the light source emits a first light beam having a first wavelength and a second wavelength at a first radial distance from the optical axis and a second light beam having the first wavelength and the second wavelength at a second radial distance from the optical axis;
disposing a first lens system along the optical axis between the extended light source and the optical target, wherein the first lens system is an achromatic lens system;
disposing a second lens system along the optical axis between the first lens system and the optical target, wherein the first light beam at the first wavelength passes through the first lens system and the second lens system to illuminate the optical target with a first collection probability, the first light beam at the second wavelength passes through the first lens system and the second lens system to illuminate the optical target with a second collection probability, the second light beam at the first wavelength passes through the first lens system and the second lens system to illuminate the optical target with a third collection probability, and the second light beam at the second wavelength passes through the first lens system and the second lens system to illuminate the optical target with a fourth collection probability; and
adjusting at least one of a first location of the first lens system and a second location of the second lens system so that the first collection probability, the second collection probability, the third collection probability, and the fourth collection probability are the same within a criterion.

12. The method of claim 11, wherein the first lens system and the second lens system combine to form a Koehler lens system.

13. The method of claim 11, wherein the first light beam at the first wavelength and the first light beam at the second wavelength arrive from the first lens system at the second lens system with the same initial conditions.

14. The method of claim 11, wherein the optical target includes an aperture of an optical fiber defining a collection area, wherein the first collection probability of the first light beam is the same as the second collection probability across the collection area.

15. The method of claim 14, wherein the aperture is about 0.5 millimeters in radius.

16. The method of claim 11, wherein a first focal length of the first lens system is longer than a second focal length of the second lens system.

17. The method of claim 11, wherein the first radial distance and the second radial distance are each within approximately 6 millimeters of the optical axis.

18. The method of claim 11, wherein the criterion includes that the first collection probability and the second collection probability are within 10% of each other at each radial position of the first light beam and the second light beam.

19. The method of claim 11, wherein a selected range of wavelengths for the first wavelength and the second wavelength is between 250 nm and 800 nm.
